(19) United States
(12) Patent Application Publication
(10) Pub. No.: US 2018/0143371 A1
(43) Pub. Date: May 24, 2018

(54) GLASS ARTICLE FOR ILLUMINATING A DISPLAY PANEL

(71) Applicant: Corning Incorporated, Corning, NY (US)

(72) Inventors: Jacques Gollier, Redmond, WA (US); Shenping Li, Painted Post, NY (US); Xinghua Li, Horseheads, NY (US); Garrett Andrew Piech, Corning, NY (US); Sergio Tsuda, Horseheads, NY (US)

(21) Appl. No.: 15/573,022

(22) PCT Filed: May 12, 2016
(86) PCT No.: PCT/US2016/032016

§ 371 Date: Nov. 9, 2017

Related U.S. Application Data
(60) Provisional application No. 62/162,234, filed on May 15, 2015.

(51) Int. Cl. F21V 8/00; C03B 17/06; C03B 25/08

(52) U.S. Cl. CPC G02B 6/0068; G02B 6/0018; G02B 6/0078; C03B 33/07; C03B 17/06; C03B 25/08; G02B 6/0073; G02B 6/0043

(57) ABSTRACT

Described herein is a glass article, for example a light guide plate, for illuminating a display panel, and in particular a light guide plate comprising a glass substrate formed by a plurality of individual segments, the plurality of glass segments arranged edge-to-edge in a two dimensional array and laminated between at least two polymer films. A display device incorporating the glass article is also described.

This application claims the benefit of priority under 35 U.S.C. § 119 of U.S. Provisional Application No. 62/162,234, filed on May 15, 2015, the content of which is relied upon and incorporated herein by reference in its entirety.

### FIELD

Described herein is a glass article such as a light guide plate for improving the illumination of display panels used in display devices, for example televisions and computer monitors. A display device incorporating the glass article is also described.

### TECHNICAL BACKGROUND

Modern edge lighted liquid crystal displays (LCDs) typically use a back light unit to distribute the light behind the LCD array in an even intensity across the entire surface of the panel. In such displays, the LED light is coupled into the light guide plate from at least one edge of a light guide plate (the coupling edge(s)) and light is extracted as it propagates by diffusing structures, typically white paint or surface scattering components, on the light guide plate (LGP). Edge lighted light guide plates present significant advantages over direct illumination, where a square array of LEDs is used to directly illuminate the panel, because the panel in edge lighted applications can be made extremely thin. However, one advantage direct illumination has over edge lighted displays is that every single LED of the array can be driven separately so that dimmer areas of displayed images can be illuminated with less light by dimming some of the LED's. This is referred to as “local dimming”, which provides savings in energy consumption and also improves image contrast, especially in the black regions of a picture. While local dimming has also been introduced into edge lighted light guide plates, the efficiency is relatively low and the improvement in image contrast is less effective because the light emitted by individual LED's rapidly expands into the light guide plate as the light propagates, providing less discrimination between the pixels. Simply put, current methods of local dimming for edge lighted LGPs fail to satisfy the needs of the manufacturers and customers in the display industry.

### SUMMARY

In a first embodiment, a light guide plate is disclosed comprising a glass substrate comprising a thickness in a range from about 0.5 millimeters to about 3 millimeters laminated between a first polymer film and a second polymer film, the glass substrate comprising a plurality of individual rectangular glass segments arranged in a two dimensional array (e.g., an n×m array where n represents the number of rows and m represents the number of columns). The two dimensional array may be, for example, at least a 10×10 array. The plurality of glass segments can be arranged edge-to-edge. For example, the glass substrate may be a rectangular glass substrate and each glass segment may be a rectangular glass segment, wherein the glass segments are arranged side by side so that their respective adjacent edges are parallel.

A thickness of the first and second polymer films may be less than about 10% of a thickness of the glass substrate.

The light guide plate may further comprise an intermediate layer between the first polymer film and the glass substrate, wherein an index of refraction of the intermediate layer is equal to or less than 1.4. The intermediate layer may be, for example, a layer of MgF₂. In various other embodiments the intermediate layer may be an epoxy.

An optical loss of the glass substrate can be equal to or less than about 3 dB/meter at a wavelength of 550 nanometers. Thus, the optical loss of any individual glass segment of the plurality of glass segments can be equal to or less than about 3 dB/meter at a wavelength of 550 nanometers.

The light guide plate may further comprise at least one light source optically coupled to an edge of the substrate and configured to inject light into the substrate. For example, the at least one light source may comprise a plurality of light emitting elements, such as a plurality of light emitting diodes (LEDs).

The light guide plate may further comprise at least one light emitting element optically coupled to each segment of at least one edge row of the two dimensional array.

The light guide plate may further comprise at least one light emitting element optically coupled to each segment of at least one edge column of the two dimensional array.

Each light emitting element of the at least one light element optically coupled to each segment of the at least one edge row and the at least one edge column may be separately controllable.

In another embodiment, a glass article is described comprising a glass substrate laminated between a first polymer film and a second polymer film, the glass substrate comprising a plurality of polygonal glass segments arranged in an array of n rows and m columns. For example, n and m may each be in a range from 2 to 500. The plurality of glass segments may be arranged edge-to-edge

In embodiments described herein, an optical attenuation of any individual glass segment of the plurality of glass segments may be equal to or less than 3 dB/meter at a wavelength of 550 nanometers.

In embodiments, a thickness of the first and second polymer films is less than 10% of a thickness of the glass substrate. A thickness of the glass substrate may be in a range from 0.5 millimeters to about 3 millimeters.

The glass article may further comprise an intermediate layer between the first polymer film and the glass substrate, wherein an index of refraction of the intermediate layer is equal to or less than 1.4. For example, the intermediate layer can comprise MgF₂ and/or an epoxy.

The glass article may further comprise at least one light source optically coupled to an edge of the glass substrate and configured to inject light into the glass substrate. The light source may be, for example, an array, such as a linear array, of light emitting elements, e.g., LEDs.

The glass article may comprise at least one light emitting element optically coupled to each glass segment of at least one edge row of the array. That is, wherein each glass segment is paired with a light emitting element, each light emitting element optically coupled with a respective glass segment.

The glass article may similarly further comprise at least one light emitting element optically coupled to each glass segment of at least one edge column of the array.

Each light emitting element optically coupled to each glass segment of the at least one edge row and the at least one edge column may be separately controllable.

In embodiments described herein, a concentration of iron in the glass substrate may produce less than 1.1 dB/500 millimeter of optical attenuation in the glass substrate.

In embodiments described herein, a concentration of iron in the glass substrate can be less than 50 ppm.

In embodiments described herein, the glass substrate may comprise iron, and at least 10% of the iron is Fe⁺².

A thermal conduction of the glass substrate may be greater than 0.5 Watts/meter/Kelvin.

In embodiments described herein, the glass article may comprise a light guide plate.

In embodiments described herein, the glass article may comprise a display backlight unit.

In embodiments described herein the glass article may comprise a display device. In another embodiment, a display device is disclosed comprising a display panel; and a backlight unit positioned adjacent the display panel, the backlight unit comprising a light guide plate including a glass substrate laminated between a first polymer film and a second polymer film, the glass substrate comprising a plurality of individual glass segments arranged in a two dimensional array, and at least one light source optically coupled to an edge of the glass substrate and configured to inject light into the glass substrate.

The light source may comprise a plurality of light emitting elements, at least one light emitting element of the plurality of light emitting elements optically coupled to each glass segment of at least one edge row of the two dimensional array.

It is to be understood that both the foregoing general description and the following detailed description are merely exemplary, and are intended to provide an overview or framework for understanding.

### BRIEF DESCRIPTION OF THE DRAWINGS

The accompanying drawings are included to provide a further understanding, and are incorporated in and constitute a part of this specification.

FIG. 1A is a front view of a diced light guide plate according to the present disclosure;

FIG. 1B is an edge view of the diced light guide plate of FIG. 1A;

FIG. 2 is a front view of a diced light guide plate according to the present disclosure comprising a single light source with a plurality of light elements arranged in a linear array;

FIG. 3 is a front view of a diced light guide plate according to the present disclosure comprising at least two light sources, each light source including a plurality of light elements arranged in a linear array;

FIG. 4 is a front view of a diced light guide plate according to the present disclosure comprising light source with a plurality of light elements arranged in a linear array positioned at each edge surface of a glass substrate comprising the light guide plate;

FIG. 5 is a cross sectional edge view of a display device comprising a backlight unit including a diced light guide plate.

FIG. 6 is a photograph of a light guide plate according to embodiments disclosed herein comprising a plurality of individual glass segments arranged edge-to-edge and lighted from one (center) row and one (center) column.

### DETAILED DESCRIPTION

Apparatus and methods will now be described more fully hereinafter with reference to the accompanying drawings in which example embodiments of the disclosure are shown. Whenever possible, the same reference numerals are used throughout the drawings to refer to the same or like parts. However, this disclosure may be embodied in many different forms and should not be construed as limited to the embodiments set forth herein.

In this specification and in the claims that follow, reference will be made to a number of terms that shall be defined to have the following meanings:

Throughout this specification, unless the context requires otherwise, the word “comprise,” or variations such as “comprises” or “comprising,” will be understood to imply the inclusion of a stated integer or step or group of integers or steps but not the exclusion of any other integer or step or group of integers or steps. Where comprise, or variations thereof, appears the terms “consists essentially of” or “consists of” may be substituted.

As used in the specification and the appended claims, the singular forms “a,” “an” and “the” include plural referents unless the context clearly dictates otherwise. Thus, for example, reference to “a pharmaceutical carrier” includes mixtures of two or more such carriers, and the like.

“Optional” or “optionally” means that the subsequently described event or circumstance can or cannot occur, and that the description includes instances where the event or circumstance occurs and instances where it does not.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As noted previously, LCD backlight units comprising edge lighted light guide plates offer significant advantages by facilitating thinner display panels. However, edge lighted LGPs have traditionally suffered from issues of image contrast and energy usage because local dimming has either been unavailable, or less effective, than in directly illuminated LCD displays. More particularly, light from an individual LED in an edge lighted light guide plate rapidly expands through a region of the light guide plate much larger than the initially lighted area proximate the LED. Therefore, in the case of an edge lighted display, simply individually manipulating the light output of the LEDs arrayed along the edge of the light guide plate will not give the same local dimming effect achievable in direct lighted displays.

Accordingly, in one embodiment, a light guide plate is disclosed wherein the light guide plate comprises a visually transparent substrate, for example a glass substrate, separated into a plurality of segments. The plurality of segments are laminated between polymer films to maintain a proper relationship between adjacent segments. The resultant light guide plate is hereinafter referred to as a “diced light guide plate”. As used herein, the term “diced” is intended to represent the result of cutting the glass substrate into a plurality of individual polygonal segments. The polygonal segments can have three or more sides (edges) and may, for example, be triangular, rectangular, square, hexagonal or another suitable geometry in form.

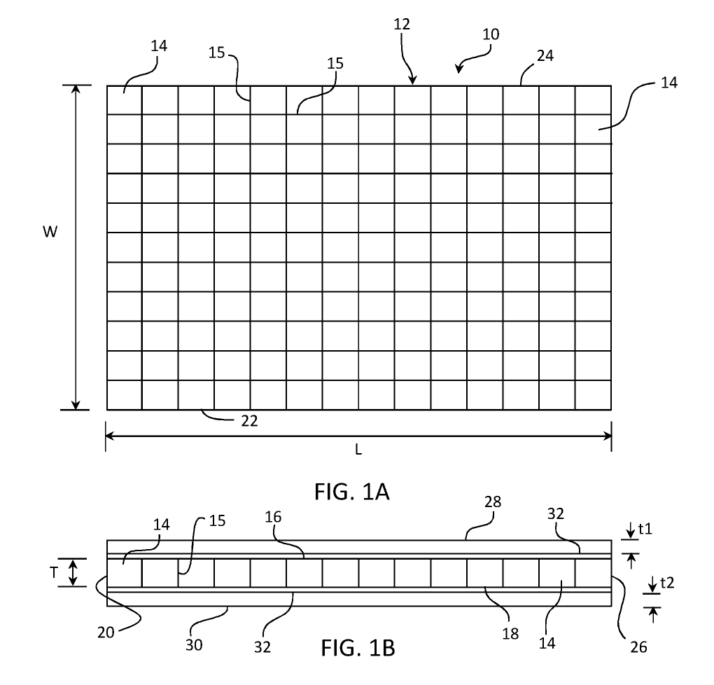

FIGS. 1A and 1B show respectively a front view of an exemplary diced light guide plate 10 and an edge view of the diced light guide plate according to various embodiments of the present disclosure. Diced light guide plate 10 comprises a glass substrate 12 including a height H, a length L, and which glass substrate 12 is comprised of a plurality of individual segments 14 arranged in a two dimensional array along the H and L dimensions. The number of individual glass segments can be varied depending on the size of the display panel lighted by the diced light guide plate and the desired lighting resolution. That is, the greater the number of segments, the greater the ability to differentiate bright regions from dark regions of an image. However, the greater the number of segments, the greater also the number of LEDs needed to fully address (e.g., light) the individual segments and therefore the greater the display cost. In various examples, the glass substrate may comprise an n×m array of glass segments separated by gap lines 15, wherein n is a whole number equal to or greater than 2 and m is a whole number equal to or greater than 2. In the n×m array, n and m need not be of equal value. In various non-limiting embodiments, n may be in a range from 2 to 500, for example from 2 to 450, from 2 to 400, from 2 to 350, from 2 to 300, from 2 to 250, from 2 to 200, from 2 to 150, from 2 to 100, or from 2 to 50, including all ranges and subranges therebetween. In various non-limiting embodiments, m may be in a range from 2 to 500, for example from 2 to 450, from 2 to 400, from 2 to 350, from 2 to 300, from 2 to 250, from 2 to 200, from 2 to 150, from 2 to 100, or from 2 to 50, including all ranges and subranges therebetween. It should be noted, however, that the number of individual glass segments can exceed 500 and can depend on, for example, the size of the glass substrate. For example, larger glass substrates, can accommodate larger numbers of individual glass segments.

Each gap line 15 represents an interface between the edge faces of adjacent individual glass segments and therefore also represents a cut line along which the glass substrate was scored and or cleaved (cut). By way of example, FIG. 1A illustrates a diced light guide plate comprising an 11×14 array of individual glass segments (i.e., 154 individual glass segments arranged in an array of 11 rows and 14 columns). In some embodiments, glass segments may have different or similar dimensions in an array, in a row and/or in a column.

As best seen in FIG. 1B, glass substrate 12 further comprises a first major surface 16, which is a discontinuous surface and may be a front surface, and a second major surface 18, which is also a discontinuous surface and may be a back surface. A discontinuous surface can be defined as a surface that is broken by discontinuities formed by the cut edges of the individual segments of the substrate. In addition, glass substrate 12 comprises a thickness T between the first and second major surfaces, which thickness forms four edge surfaces extending around each segment. Accordingly, an outside row or column of the array of segments may comprise an edge surface (albeit discontinuous because the of the gap lines) of the array, which is the sum of the individual outside edges of the plurality of segments comprising the outside row or column of segments. Thickness T may be substantially uniform, meaning that in various embodiments first major surface 16 and second major surface 18 are substantially parallel (i.e., wherein each segment comprises the same thickness T). The thickness T can be in a range from about 0.1 millimeters to about 3 millimeters, from about 0.5 millimeters to about 3 millimeters, for example in a range from about 0.6 millimeters to about 2.5 millimeters, or in a range from about 0.7 millimeters to about 20 millimeters, and all ranges and subranges therebetween.

A first edge surface 20 of glass substrate 12 may be a light injection edge surface that receives light provided for example by a light emitting element, e.g., a light emitting diode (LED). The light injection edge should scatter light within an angle less than 12.8 degrees full width half maximum (FWHM) in transmission. The light injection edge may in some instances be obtained by grinding the edge surface without polishing the light injection edge.

Glass substrate 12 may further comprise a second edge surface 22 adjacent to first edge surface 20, a third edge surface 24 opposite second edge surface 22 and adjacent to the first edge surface 20, and a fourth edge surface 26 opposite first edge surface 20, and wherein second edge surface 22 and/or third edge surface 24 and/or fourth edge surface 26 may scatter light within an angle of less than 12.8 degrees FWHM in reflection. First edge surface 20, second edge surface 22, third edge surface 24 and/or fourth edge surface 26 may have a diffusion angle in reflection that is below 6.4 degrees. As noted above, while the foregoing description suggests a continuous edge surface of each of edge surfaces 20, 22, 24 and 26, such edge surfaces are in fact discontinuous edge surfaces owing to the diced nature of the glass substrate. However, for purposes of explanation and not limitation, treating these edge surfaces as continuous in certain descriptions is intended to simplify the disclosure.

Glass substrate 12 is laminated between at least two polymer films, a first polymer film 28 disposed on first major surface 16 and a second polymer film 30 disposed on second major surface 18. The polymer films 28, 30 hold the individual segments 14 of glass substrate 12 in a predetermined spatial relationship and provide rigidity to the diced light guide plate.

Because it is a function of the diced light guide plate to provide illumination to a display panel, such as a liquid crystal display panel by redirecting light injected from an edge surface of the diced light guide plate to a forward direction (toward a display panel) from one of the first or second major surfaces 16, 18, respectively, the first and/or second polymer films 28, 30 should present a low optical loss within the visual wavelength range. In one example, the first and/or second polymer film may be formed from a substantially transparent material, for example polymethyl methacrylate (PMMA), polycarbonate, polyvinyl butyral, and the like. In other examples, a thickness t1 of the first polymer film 28 and/or a thickness t2 of the second polymer film 30 may be made as thin as practical and still perform its intended functions. To that end, the first and/or second polymer films 28, 30 can have a thickness that is equal to or less than 10% of the thickness T of the diced light guide plate.

In some embodiments, an optional additional layer 32 may be included between one or both of the first and second polymer films 28, 30 and glass substrate 12. The additional layer 32 can comprise a material with a low index of refraction, for example equal to or less than about 1.4. In one particular embodiment, the diced light guide plate can include a layer of MgF₂ between one or both of the first or second polymer films 28, 30 and glass substrate 12. In other embodiments, an epoxy can be used.

In still other embodiments, the diced light guide plate can comprise a low optical loss glass substrate, for example a glass having low iron content. The glass substrate before dicing should have an optical loss (i.e. optical attenuation) equal to or less than about 3 dB/meter. Thus, each individual glass segment comprising the glass substrate after dicing should have an optical attenuation equal to or less than about 3 dB/meter.

According to one or more embodiments, glass substrate 12 may be made from a glass comprising colorless oxide components selected from the glass formers SiO₂, Al₂O₃, and B₂O₃. The glass may also include fluxes to obtain favorable melting and forming attributes. Such fluxes can include alkali oxides (Li₂O, Na₂O, K₂O, Rb₂O and Cs₂O) and alkaline earth oxides (MgO, CaO, SrO and BaO). In one embodiment, the glass contains SiO₂ in a range from about 50 to about 80 mol %, Al₂O₃ in a range from about 0 to about 20 mol % and B₂O₃ in a range from about 0 to about 25 mol %. The glass may further comprise alkali oxides, alkaline earth oxides, or combinations thereof in a range from about 5 to about 20%. In various embodiments, the thermal conduction of the glass substrate 12 may be greater than 0.5 Watts/meter/Kelvin (W/m/K).

In various embodiments, the mole % of Al₂O₃ may be in a range from about 5% to about 22%, or alternatively in a range from about 10% to about 22%, or in a range from about 18% to about 22%. In some embodiments, the mole % of Al₂O₃ may be about 20%.

In various embodiments, the mole % of B₂O₃ may be in a range from about 0% to about 20%, or alternatively in a range from about 5% to about 15%, or in a range from about 5% to about 10%. In some embodiments, the mole % of B₂O₃ may be about 5.5%.

In various embodiments, the glass may comprise RₓO_{2/x} where R is Li, Na, K, Rb, Cs, and x is 2, or R is Mg, Ca, Sr or Ba, and x is 1, and the mole % of RₓO_{2/x} is approximately equal to the mole % of Al₂O₃. Alternatively, in various embodiments the Al₂O₃ mole % may be in a range from about 4 mole % greater than the RₓO_{2/x} to about 4 mole % less than the RₓO_{2/x}.

In one or more embodiments, glass substrate 12 includes low concentrations of elements that produce visible absorption when in a glass matrix. Such optical absorbers include transition elements such as Ti, V, Cr, Mn, Fe, Co, Ni and Cu, and rare earth elements with partially-filled f-orbitals, including Ce, Pr, Nd, Sm, Eu, Tb, Dy, Ho, Er and Tm. Of these, the most abundant in conventional raw materials used for glass melting are Fe, Cr and Ni. Iron is a common contaminant in sand, the source of SiO₂, and is a typical contaminant as well in raw material sources for aluminum, magnesium and calcium. Chromium and nickel are typically present at low concentration in normal glass raw materials, but can also be introduced via contact with stainless steel, e.g., when raw material or cullet is jaw-crushed, through erosion of steel-lined mixers or screw feeders, or unintended contact with structural steel in the melting unit itself. Consequently, the concentration of iron in the glass is specifically held to less than 50 ppm, more specifically less than 40 ppm, or less than 25 ppm, and the concentration of Ni and Cr are specifically less than 5 ppm, and more specifically less than 2 ppm. In some embodiments, the concentration of all other light absorbers listed above may be specifically less than 1 ppm for each. In various embodiments, the glass may comprise 1 ppm or less of Co, Ni, and Cr, or alternatively less than 1 ppm of Co, Ni, and Cr. In various embodiments, the transition elements (V, Cr, Mn, Fe, Co, Ni and Cu) may be present in the glass at concentrations of 0.1 weight % or less.

Even in the case that the concentrations of transition metals are within the foregoing ranges, there can be matrix and redox effects that result in undesired optical absorption. As an example, it is well-known to those skilled in the art that iron occurs in two valences in glass, the +3 or ferric state, and the +2 or ferrous state. In glass, Fe3+ produces absorptions at approximately 380, 420 and 435 nanometers, whereas Fe2+ absorbs mostly at infrared (IR) wavelengths. Therefore, according to one or more embodiments, it is desirable to force as much iron as possible into the ferrous state to achieve high transmission at visible wavelengths. One method to accomplish this is to add components to the glass batch that are reducing in nature. Such components could include carbon, hydrocarbons, or reduced forms of certain metalloids, e.g., silicon, boron or aluminum. However it is achieved, if iron levels are within the described range, according to one or more embodiments at least 10% of the iron is in the ferrous state, and more specifically greater than 20% of the iron is in the ferrous state to produce adequate transmission at short wavelengths.

In various embodiments, the concentration of iron in the glass produces less than 1.1 dB/500 millimeter of optical attenuation in the glass substrate.

In various embodiments, the concentration of V+Cr+Mn+Fe+Co+Ni+Cu produces 2 dB/500 millimeter or less of optical attenuation in the glass sheet when the concentration ratio (Li₂O+Na₂O+K₂O+Rb₂O+Cs₂O+MgO+CaO+SrO+BaO)/Al₂O₃ for borosilicate glass is 1±0.2.

It should be noted that any one or more of the foregoing methods of achieving low optical loss in the polymer films or the glass substrate can be applied.

It should be further noted that the application of a polymer film to first major surface 16 and second major surface 18 facilitates the use of a selected one (or both) of the polymer layers to be employed for light extraction. For example, a suitable light scattering texture may be formed on one or both of the polymer layers. The scattering texture may be molded in, embossed, or laser-written, although any technique known in the art capable of producing suitable light extracting features on or in one or both of the polymer layers 28, 30 can be used.

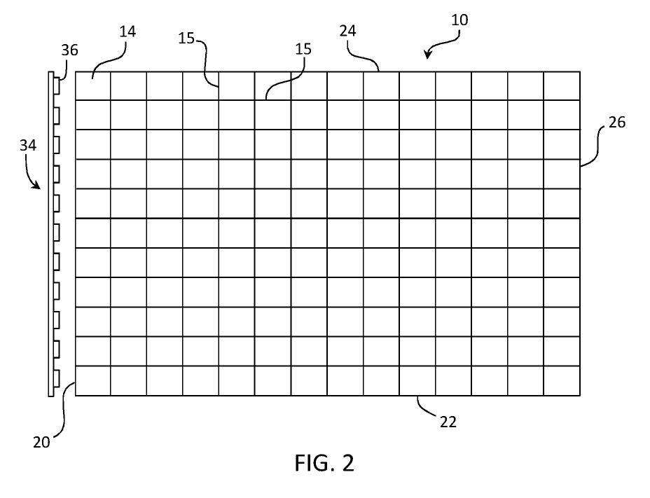

In accordance with various embodiments, diced light guide plate 10 may further comprise a light source 34 (see FIG. 2) comprising at least one light emitting element 36 configured to inject light into at least one edge surface of glass substrate 12, for example first edge surface 20. Light source 34 may, for example, be an individual light emitting element 36, or light source 34 may be an array of light emitting elements 36, for example a strip light source wherein a plurality of individual light emitters are arranged in a linear array along first edge surface 20. In various embodiments, the individual light emitting elements 36 may be light emitting diodes (LEDs). For example, a plurality of light emitting diodes may be arranged on a circuit board as a linear array and positioned adjacent a selected edge surface of glass substrate 12 such that at least one light emitting diode is associated with each individual glass segment.

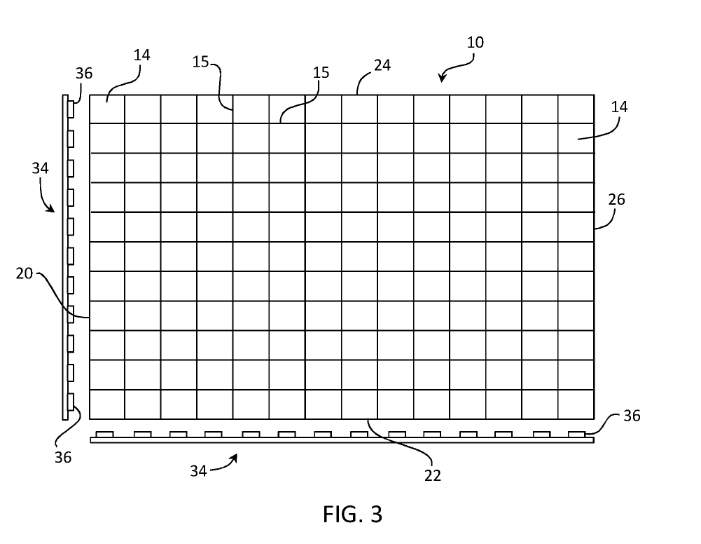

In some embodiments, for example the embodiment illustrated in FIG. 3, light guide plate 10 may comprise a plurality of light sources. For example, in some embodiments, the light guide plate 10 may comprise at least two light sources 34, wherein one light source 34 is arranged adjacent and along one edge surface of the light guide plate, and the other light source 34 is arranged adjacent and along another edge surface of the light guide plate. In various particular embodiments, the at least two light sources can be arranged perpendicular to each other. Thus, in respect of FIG. 3, one light source 34 may be arranged adjacent to and along an outside edge column of light guide plate 10 in the H direction, while another light source 34 may be arranged adjacent to and along an outside edge row of light guide plate 10 in the L direction. As used herein, an outside edge row, or an outside edge column, refers to an outside column or outside row of individual glass segments 14 of light guide plate 10, wherein each individual glass segment 14 of the outside column or outside row includes at least one edge surface that is an outside edge surface of glass substrate 12. In various other embodiments, the at least two light sources 34 may be arranged adjacent and long opposing edge surfaces. In still other embodiments, light sources 34 may be arranged along both adjacent and opposite edge surfaces. As in the preceding embodiment, a plurality of light emitting diodes may be arranged on a circuit board as a linear array and positioned adjacent a selected edge surface of glass substrate 12 such that at least one light emitting element is associated with each individual glass segment 14.

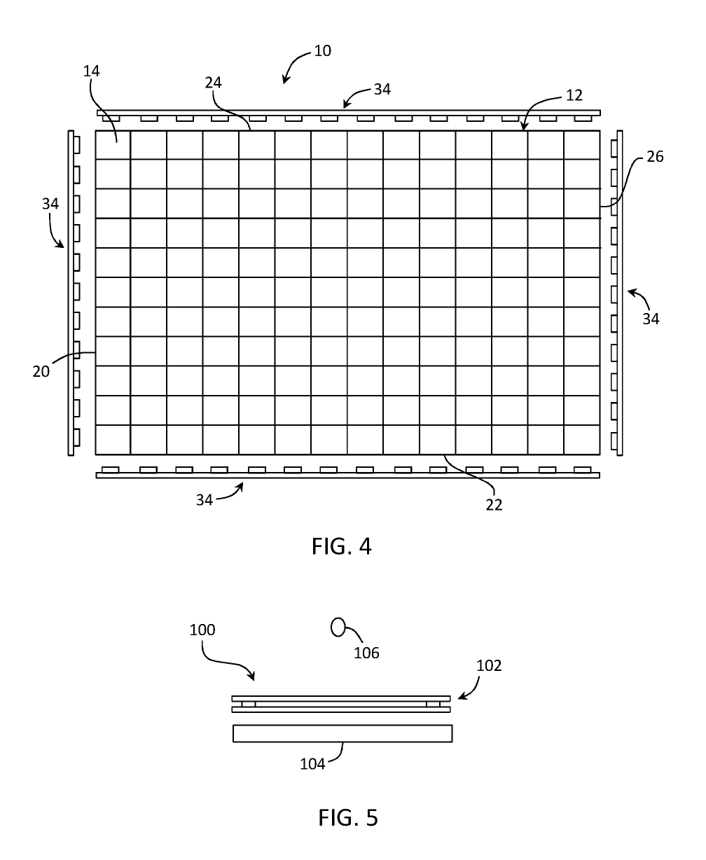

In still other embodiments, as depicted in FIG. 4, light guide plate 10 may comprise a light source arranged adjacent to and along each edge surface of glass substrate 12.

In accordance with embodiments of the present disclosure, light injected into a particular row or column of individual glass segments 14 is propagated through each segment by total internal reflection. The light that reaches a cut edge surface of a particular individual glass segment is transmitted through the cut surface into the adjacent cut edge surface, whereupon the light continues to propagate through that subsequent individual glass segment, and so on. Owing to the close tolerance and complimentary topography of the adjacent end surfaces, as discussed farther below, optical loss across adjacent edge surfaces perpendicular to the general direction of propagation of the light is minimized. On the other hand, light that intersects edge surfaces that extend generally in the same direction as the direction of propagation is internally reflected and continues to be guided through the individual glass segment until extracted out of the glass substrate (e.g. the individual glass segment), for example by scattering, produced, for example, by the polymer films.

From the foregoing it can be seen that light injected into any given row or column of glass substrate 12 will be propagated through that particular row or column with minimal leakage into an adjacent row or column. Accordingly, any particular individual glass segment 14 can be “addressed” by illuminating the appropriate light elements 36 associated with the row or column to which the particular individual glass segment 14 belongs. That is, the intersection of a given illuminated row and column is a particular individual glass segment 14, which particular individual glass segment 14 receives light from both the illuminated row and the illuminated column. It may be seen then that, unlike conventional dimming arrangements employing an un-diced substrate and light elements that inject light into an edge surface of the substrate, the injected light does not fan out and diffuse through the glass substrate, but is confined within the particular row or column into which the light was injected. Thus, the individual glass segment 14 that is the intersection of the row and column into which light was injected can receive strong lighting, whereas adjacent segments can remain essentially dark. A direct analogy is that the individual glass segments 14 can be made to behave as individually addressable pixels, wherein by selecting the appropriate row and column of individual glass segments, a single individual glass segment 14 can be made to produce greater illumination than adjacent glass segments. This action can be expanded so that entire regions, predetermined regions, or selected regions of the glass substrate can be made to produce more or less illumination that other regions of the glass substrate simply by injecting (or withholding) light into the appropriate number of rows and columns. It should be understood that any one or more predetermined regions or selected regions can be lighted (or not lighted if the region is to remain dark) individually by individually controlling one or more individual light emitting elements (e.g., LEDs).

Glass substrate 12 can be any suitable glass substrate having the requisite low loss. The glass substrate can be a glass substrate produced by any suitable glass substrate manufacturing process, for example without limitation an up draw process, a down draw process such as a fusion down draw process, a float process, a redraw process or a slot draw process. The following description sets forth an exemplary method of producing the diced light guide plate from a glass substrate 12.

In a first step, a suitable glass substrate is laminated on one major surface, for example first major surface 16, with a suitable first polymer film 28. Care should be taken to ensure the polymer film is well adhered to the glass substrate surface without air trapped between the polymer film and the glass substrate (i.e., without air bubbles). Once the first polymer film 28 is adhered to the first major surface 16 of glass substrate 12, the glass substrate 12 is diced by forming a two dimensional array of parallel and perpendicular cuts in the glass substrate. For example, in some embodiments glass substrate 12 may be laser scored using a conventional laser scoring technique. Non-limiting exemplary methods and lasers suitable for laser scoring glass are disclosed, for instance, in U.S. application Ser. Nos. 14/145,525; 14/530,457; 14/535,800; 14/535,754; 14/530,379; 14/529,801; 14/529,520; 14/529,697; 14/536,009; 14/530,410; and Ser. No. 14/530,244; and International Application Nos. PCT/EP14/055364; PCT/US15/130019; and PCT/US15/13026. By way of example and not limitation, in various embodiments, a first plurality of parallel scores may be formed, followed by a second plurality of parallel scores, wherein the second plurality of scores are perpendicular to the first plurality of scores. Separation of the glass substrate can then be accomplished by bending the glass substrate along the individual core lines.

As related above, it is desirable that adjacent edge surfaces of adjacent individual glass segments 14 are as complimentary as possible, meaning, for example, that a normal to one glass edge surface intersects the adjacent edge as surface normal. Thus, if scoring is used, the score depth should be no greater than about 20% of the total thickness of glass substrate 12 such that the remainder of the adjacent edge surfaces are mirror surfaces with complimentary topography. This ensures a minimal gap between adjacent edge surfaces and minimal optical losses as the light propagates from one segment to another segment.

In various embodiments, the glass substrate may be diced by producing full body cuts in the glass substrate without the need to first produce a score, thereby forming edge surfaces without significant surface damage.

It should be apparent that a diced light guide plate according to embodiments disclosed herein can be used in a variety of display devices. For example, a diced light guide plate as described herein may comprise a backlight unit useable in flat panel televisions, computer monitors, computer tablets and the like. FIG. 5 illustrates an exemplary display device 100 comprising a display panel 102, for example a liquid crystal display panel, and a backlight unit 104 comprising a light guide plate 10 according to embodiments described herein. Display panel 102 is positioned between backlight unit 104 and a viewer 106 of the display panel 102.

### Example

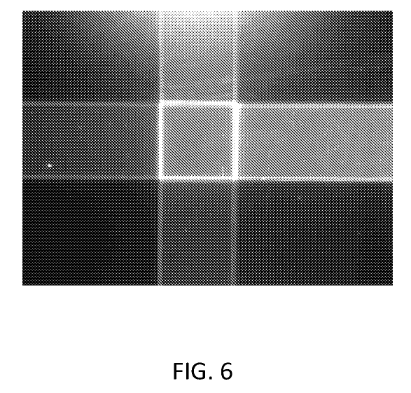

Referring to FIG. 6, a polymer film was applied to one major surface of a glass substrate having dimensions 300 millimeters×700 millimeters. The glass substrate was then scored using a CO₂ laser to form 4 score lines, two “vertical” score lines and two “horizontal” score lines. The glass substrate was then cleaved along the score lines by bending, thereby producing three columns and three rows of individual glass segments. The glass substrate was then laminated with a second sheet of polymer film on the second major surface of the glass substrate. The center row and the center column were then each lighted with a single light emitting diode, the center column via the top edge face of the glass substrate, and the center row via the right hand edge face of the glass substrate. The figure clearly shows how the light for each lighted column and row is guided within that row or column, and that the intersection of the row and column is the center individual glass segment of the substrate. Additionally, it is also apparent that the center individual glass segment is brighter than the immediately adjacent portion of any of the adjacent rows or columns. It should be noted that no light extraction features were intentionally applied in the example. The bright borders along the center row and column are due to light scattering at the interface between each row and column (i.e. at the cut edge surfaces).

Although the embodiments herein have been described with reference to particular aspects and features, it is to be understood that these embodiments are merely illustrative of desired principles and applications. It is therefore to be understood that numerous modifications may be made to the illustrative embodiments and that other arrangements may be devised without departing from the spirit and scope of the appended claims.

1. A glass article comprising:
a glass substrate laminated between a first polymer film and a second polymer film, the glass substrate comprising a plurality of polygonal glass segments arranged in an array of n rows and m columns.

2. The glass article according to claim 1, wherein n and m are each in a range from 2 to 500.

3. The glass article according to claim 1, wherein an optical attenuation of any individual glass segment of the plurality of glass segments is equal to or less than 3 dB/meter at a wavelength of 550 nanometers.

4. The glass article according to claim 1, wherein the plurality of glass segments are arranged edge-to-edge.

5. The glass article according to claim 1, wherein a thickness of the first and second polymer films is less than 10% of a thickness of the glass substrate.

6. The glass article according to claim 1, wherein a thickness of the glass substrate is in a range from 0.5 millimeters to about 3 millimeters.

7. The glass article according to claim 1, further comprising an intermediate layer between the first polymer film and the glass substrate, wherein an index of refraction of the intermediate layer is equal to or less than 1.4.

8. The glass article according to claim 7, wherein the intermediate layer is a layer of MgF₂.

9. The glass article according to claim 1, further comprising at least one light source optically coupled to an edge of the glass substrate and configured to inject light into the glass substrate.

10. The glass article according to claim 1, further comprising at least one light emitting element optically coupled to each glass segment of at least one edge row of the array.

11. The glass article according to claim 10, further comprising at least one light emitting element optically coupled to each glass segment of at least one edge column of the array.

12. The glass article according to claim 11, wherein each light emitting element optically coupled to each glass segment of the at least one edge row and the at least one edge column is separately controllable.

13. The glass article according to claim 1, wherein a concentration of iron in the glass substrate produces less than 1.1 dB/500 millimeter of optical attenuation in the glass substrate.

14. The glass article according to claim 1, wherein a concentration of iron in the glass substrate is less than 50 ppm.

15. The glass article according to claim 14, wherein at least 10% of the iron is Fe⁺².

16. The glass article according to claim 1, wherein a thermal conduction of the glass substrate is greater than 0.5 Watts/meter/Kelvin.

17. The glass article according to claim 1, wherein the glass article comprises a light guide plate.

18. The glass article according to claim 1, wherein the glass article comprises a display backlight unit.

19. A display device comprising:
a display panel; and
a backlight unit positioned adjacent the display panel, the backlight unit comprising a light guide plate including a glass substrate laminated between a first polymer film and a second polymer film, the glass substrate comprising a plurality of individual glass segments arranged in a two dimensional array, and at least one light source optically coupled to an edge of the glass substrate and configured to inject light into the glass substrate.

20. The display device according to claim 19, wherein the light source comprises a plurality of light emitting elements, at least one light emitting element of the plurality of light emitting elements optically coupled to each glass segment of at least one edge row of the two dimensional array.
